(19) United States
(12) Patent Application Publication
(10) Pub. No.: US 2019/0257270 A1
(43) Pub. Date: Aug. 22, 2019

(54) Water Injection Device for an Internal Combustion Engine of a Motor Vehicle

(71) Applicant: Robert Bosch GmbH, Stuttgart (DE)

(72) Inventors: Ingmar Burak, Stuttgart (DE); Peter Schenk, Ludwigsburg (DE)

(73) Assignee: Robert Bosch GmbH, Stuttgart (DE)

(21) Appl. No.: 16/333,668

(22) PCT Filed: Aug. 21, 2017
(86) PCT No.: PCT/EP2017/071004

§ 371 Date: Mar. 15, 2019

(30) Foreign Application Priority Data
Sep. 16, 2016 (DE) 10 2016 217 736.2

(51) Int. Cl. F02M 25/022; F02B 47/02; F02M 25/025; C02F 1/50

(52) U.S. Cl. CPC F02M 25/0224; F02B 47/02; C02F 1/50; F02M 25/025; F02M 25/0227; F02M 25/0222

(57) ABSTRACT

A water injection device for an internal combustion engine of a motor vehicle includes at least one water injector for injecting water into an internal combustion engine. The water injection device further includes a water tank and a first supply line. The first supply line is configured to connect the water tank to the water injector. At least one biocide for controlling harmful organisms in the water injection device is provided in the water injection device.

### PRIOR ART

The invention concerns a water injection device for an internal combustion engine of a motor vehicle, with the features of the preamble of the independent claim 1.

In order to lower the temperature on a combustion process of an internal combustion engine of a motor vehicle and hence reduce a fuel consumption of the internal combustion engine and improve an emission behavior of the internal combustion engine, water may be injected into an intake pipe or a combustion chamber of the internal combustion engine. Such water injection systems normally comprise a water tank so that water is available at all times for injection into the intake pipe or the combustion chamber of the internal combustion engine. In addition, with such water injection systems, water may be recovered for example from the exhaust system of the internal combustion engine in the motor vehicle or from the environment of the motor vehicle by means of a water recovery system, and for example also supplied to the water tank.

A feature of water injection devices is that biocontamination can occur from harmful organisms in the water injection device or from the environment. Such biocontamination may adversely affect the function of the water injection device.

### DISCLOSURE OF THE INVENTION

According to the invention, a water injection device for an internal combustion engine of a motor vehicle is proposed. The water injection device comprises at least one water injector for injecting water into an internal combustion engine, at least one water tank, and at least one first supply line which is designed to connect the water tank to the water injector. According to the invention, at least one biocide for combatting harmful organisms in the water injection device is provided in the water injection device.

### Advantages of the Invention

In comparison with the prior art, the water injection device with the features of the independent claim 1 has the advantage that, due to the biocide provided in the water injection device according to the invention, biocontamination of the water injection device can advantageously be prevented or minimized. Biocontamination may occur for example in the water injection device due to pollution of water or components of the water injection device, for example from refill water and/or for example from water obtained from a water recovery device. Due to pollution, for example algae, fungi or bacteria, such as for example cyanobacteria or acetobacter or other harmful organisms, may enter the water injection device and/or settle and/or multiply therein. Such biocontamination occurs preferably in regions of the water injection device in which water stands for a longer period, such as for example the water tank, or in regions with a low through-flow speed (dead spaces). Due to biocontamination and the resulting chemical products (e.g. biofilms at interfaces), the function of the water injection device may be adversely affected or even fail completely, due for example to a clogged filter. Such problems are advantageously prevented with the water injection device according to the invention. The biocide provided for the water injection device advantageously kills and/or obstructs the growth of for example algae, fungi, bacteria and other harmful organisms, so that no or only very little biocontamination occurs in the water injection device according to the invention, with no adverse effect on the function of the water injection device.

Further advantageous embodiments and refinements of the invention are achieved by the features given in the subclaims.

Particularly advantageously, the biocide is provided in the water tank. If the biocide is arranged in the water tank, the advantage is achieved that the biocontamination of the water is countered by the biocide in a region of the water injection device which constitutes one of the regions of the water injection device most susceptible to biocontamination from the water standing in the water tank. Also, the water is usually stored in the tank for a comparatively long period and the biocide can therefore act on the water for a longer time. Thus particularly advantageously, the biocide in the water tank can counter biocontamination in the water injection device well and efficiently.

In a particularly advantageous exemplary embodiment, the biocide is configured as a coating on at least one inner wall of the water injection device. Thus, particularly advantageously, the biocontamination of the water injection device on inner walls of the water injection device can be countered and the coated inner walls can advantageously be kept free from biocontamination.

Particularly advantageously, the coating is arranged on a tank surface, wherein the tank surface is arranged in an interior of the water tank. Thus the biocontamination of the water injection device can be prevented in the tank, which is particularly susceptible to biocontamination due to the water contained therein, and the tank surface in the interior of the water tank can advantageously be kept free for example from coverings generated by biocontamination.

In a particularly advantageous exemplary embodiment, the water injection device comprises at least one metering device, wherein the metering device is configured to release biocide into the water injection device. With a metering device configured in this way, the biocide can be released in a targeted fashion, in specific quantities and/or at desired points in the water injection device, and for example also be supplied to the water in the water injection device.

Advantageously, the metering device may be arranged on or in the water tank. Due to the biocide emitted by the metering device in the water tank, the biocontamination can advantageously be countered in the water tank, which is particularly susceptible to the formation of biocontamination due to the water present in the water tank, so that the biocontamination is effectively combatted.

Advantageously, the water injection device may furthermore comprise a water recovery device, and a second supply line which is designed to connect the water recovery device to the water tank, wherein the metering device is arranged in the water recovery device and/or in the second supply line. A metering device arranged in the water recovery device and/or the second supply line can emit the biocide directly into the water recovery device and/or the second supply line for the water injection device, so that the biocontamination can advantageously be combatted directly in the region in which harmful organisms can enter the water injection device for example through the water recovery device, and the harmful organisms can advantageously be eradicated for example even before they reach e.g. the water tank.

Furthermore, the water tank may comprise a filling line for filling water into the water tank, and the metering device is arranged in the filling line. Here again, the advantage is achieved that harmful organisms which could lead to biocontamination of the water injection device can advantageously be eradicated even in a region from which they can enter the water injection device, for example the filling line, and hence biocontamination of the water injection device can advantageously be prevented.

Furthermore, in the water injection device, a return line may be provided from the first supply line to the water tank, and the metering device may advantageously be arranged in the return line. Thus, advantageously, biocide may be emitted to water running back to the water tank from the first supply line through the return line.

Particularly advantageously, the biocide is at least partially dissolved in the water arranged in the water injection device. Biocide dissolved in water can, through the water in which it is dissolved, advantageously reach all areas of the water injection device which are accessible to water, where it can effectively prevent or minimize the biocontamination in the water injection device.

### BRIEF DESCRIPTION OF THE DRAWINGS

Exemplary embodiments of the invention are shown in the drawing and explained in more detail in the description which follows. The drawings show:

FIG. 1 a diagrammatic depiction of a first exemplary embodiment of the water injection device according to the invention,

FIG. 2 a diagrammatic depiction of a second exemplary embodiment of the water injection device according to the invention.

### EMBODIMENTS OF THE INVENTION

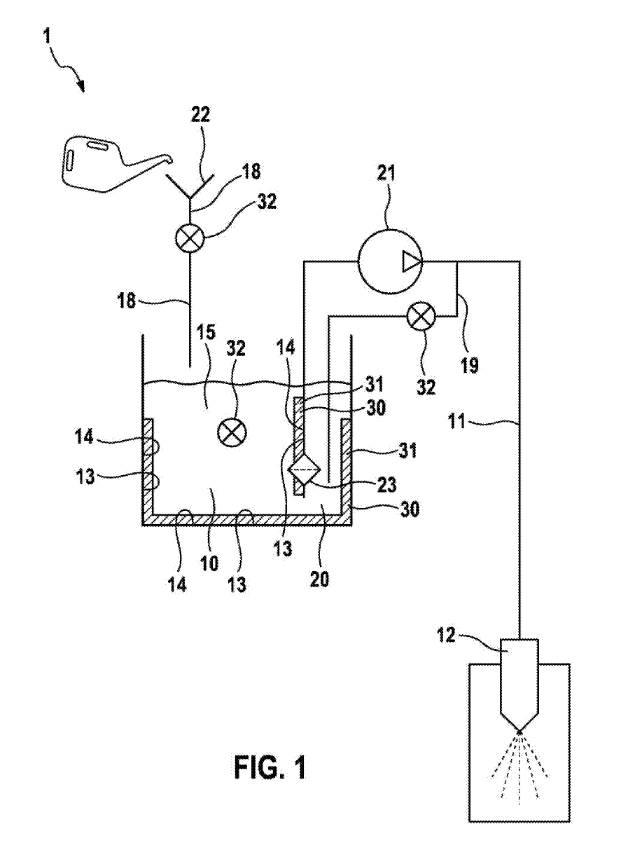

FIG. 1 shows a diagrammatic depiction of a first exemplary embodiment of the water injection device 1 according to the invention. The water injection device 1 is provided to inject water into an internal combustion engine of a motor vehicle. Water 20 may for example be injected into an intake tube or a combustion chamber of the internal combustion engine, in order for example to reduce the temperature on a combustion process of the internal combustion engine and hence reduce a fuel consumption of the internal combustion engine and improve an emissions behavior of the internal combustion engine.

The water injection device 1 shown in FIG. 1 comprises a water injector 12 which is provided to inject water 20 into the internal combustion engine of the motor vehicle. The water injector 12 in this exemplary embodiment is configured as an injector suitable for water 20.

Furthermore, the water injection device 1 comprises a water tank 10 provided for receiving and storing water which can be injected by the water injector 12 into the internal combustion engine of the motor vehicle.

The water injection device 1 furthermore comprises a first supply line 11 which connects the water tank 10 to the water injector 12. Thus water 20 is conveyed from the water tank 10 through the first supply line 11 to the water injector 12. To this end, a delivery element 21, for example a pump, may be provided in the first supply line 11 and convey the water from the water tank 10 through the first supply line 11 to the water injector 12. For example, a filter 23 for filtering the water 20 may be arranged in the first supply line 11.

The water injection device 1 in this exemplary embodiment furthermore comprises a return line 19 from the first supply line 11 to the water tank 10. In this exemplary embodiment, the return line 19 connects a region of the first supply line 11 arranged upstream of the delivery element 21 to the water tank 10. Thus the water 20 can flow back to the water tank 10 through the return line 19 from the region of the first supply line 11 arranged upstream of the delivery element 21.

Furthermore, in this exemplary embodiment, the water injection device 1 as shown in FIG. 1 comprises a filling line 18 through which water can be filled and/or added to the water tank 10. Water 20 may be filled or added to the water tank 10 through the filling line 18 by the user of the motor vehicle for example. The filling line 18 here for example connects an exterior of the motor vehicle to the water tank 10. A filler opening 22, through which water 20 can be added to the filling line 18, is formed on the filling line 18. The filling line 18 connects the filler opening 22 to the water tank 10.

To avoid and combat biocontamination from harmful organisms, a biocide 30 is provided in the water injection device 1 according to the invention. A biocide 30 in the context of the present application means a substance or substance mixture, for example in solid or liquid form, which is intended to combat harmful organisms in ways other than by purely physical or mechanical effect, i.e. to destroy, deter, render harmless, prevent the action of harmful organisms, or otherwise combat these. Harmful organisms may for example be algae, fungi, bacteria or other microorganisms which can enter the water injection device 1 and/or can form and/or multiply in the water injection device 1, in particular in the water 20 of the water injection device 1. For the present invention, for example quantities of biocide 30 are provided in the water injection device 1 which can effectively prevent damage to the water injection device 1 and/or deterioration in function of the water injection device 1 due to harmful organisms. Such damage or deterioration in function may for example be caused by the formation of coverings or by clogging, for example of filters, or also by damage to materials (metals and/or plastics) from microorganisms and their decomposition products (biocorrosion).

Depending on the requirements or the type of microorganisms, differently acting biocides may be used, for example electrophilic, lytic, oxidizing substances or a combination of differently acting biocides.

The biocide 30 of the water injection device 1 may be provided for and in different regions of the water injection device 1.

As shown in FIG. 1, the biocide 30 may be formed for example as a coating 31 on at least one inner wall 13 of the water injection device 1. In the exemplary embodiment shown in FIG. 1, this coating 31 is arranged on tank surfaces 14, wherein the tank surfaces 14 are arranged in an interior 15 of the water tank 10. If the interior 15 of the water tank 10 is for example at least partially filled with water 20, the tank surfaces 14 are in contact with the water 20 in the interior 15 of the water tank 10. A tank surface 14 may for example be an inner wall of the water tank 10 limiting the water tank 10 towards the outside, or walls or surfaces which are formed on components of the water injection device 1 arranged in the interior 15 of the water tank 10. In the exemplary embodiment shown in FIG. 1, for example surfaces of the first supply line 11 arranged in the interior 15 of the water tank 10, and hence forming the tank surfaces 14, are provided with a coating 31 of biocide 30.

A coating 31 of biocide 30 may however for example also be provided on other inner walls 13 of the water injection device 1. In the context of the present application, an inner wall 13 of the water injection device 1 means a surface which is or may come into contact with the water 20 to be injected in the water injection device 1. An inner wall 13 of the water injection device 1 may for example also be an inner wall 13 of the first supply line 11, an inner wall 13 of the filling line 18, and/or an inner wall 13 of the return line 19.

The coating 31 may be produced completely or partially of biocide 30 or a material generating and/or emitting a biocide 30. The coating 31 in this exemplary embodiment is for at least part of the time in direct contact with the water 20 of the water injection device 1 which is intended for injection. The coating 31 may thus for example prevent and/or minimize the biocontamination of the water 20. In this exemplary embodiment, the coating 31 may thereby for example also prevent harmful organisms from settling and/or multiplying on the inner walls 13 of the water injection device 1 which are provided with the coating of biocide 30, and there forming a covering for example.

The biocide 30 may also be dissolved fully or partially in the water 20 arranged in the water injection device 1. The biocide 30 may be configured as a liquid which is mixed with the water 20, or as a solid dissolved in the water 20. The biocide 30 may for example also be emitted from the coating 31 to the water 20 of the water injection device 1 and at least partially dissolved in the water 20.

The biocide 30 may however, as in this exemplary embodiment, also for example be emitted into the water of the water injection device 1 via one or more metering devices 32. In the exemplary embodiment shown in FIG. 1, the water injection device 1 comprises several metering devices 32, wherein the metering devices 32 are configured to release biocide 30 into the water injection device 1.

The metering device may for example contain a store of biocide in concentrated solid or liquid form, and may emit this to the water over a longer period. The store of biocide may be selected such that the quantity contained in the metering device is sufficient for the entire life of the vehicle. The metering device may however for example also be formed so as to be replaceable or refillable. Thus the metering device may be refilled or also replaced e.g. during maintenance and service work.

In this exemplary embodiment, the metering device 32 may be arranged for example in the water tank 10, for example in the interior 15 of the water tank 10. From there, biocide 30 may be emitted by the metering device 32 directly into the water 20 arranged in the interior of the water tank 10.

In this exemplary embodiment, the metering device 32 may also be arranged in the filling line 18 provided for filling water 20 into the water tank 10. Thus biocide 30 may for example be emitted directly to the water 20 flowing into the filling line 18.

As shown in the first exemplary embodiment in FIG. 1, the metering device 32 may for example also be arranged in the return line 19. A metering device 32 arranged in the return line 19 of the water injection device 1 may for example emit biocide 30 into the water 20 which flows back to the water tank 10 through the return line 19.

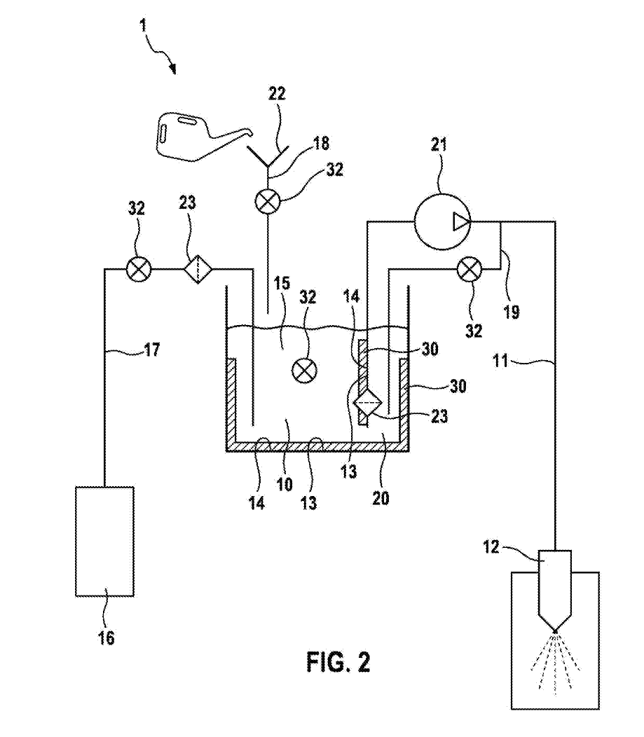

FIG. 2 shows diagrammatically a second exemplary embodiment of the water injection device 1 according to the invention. In contrast to the first exemplary embodiment of the water injection device 1 shown in FIG. 1, the water injection device 1 in the second exemplary embodiment comprises a water recovery device 16, and a second supply line 17 which is designed to connect the water recovery device 16 to the water tank 10. By means of the water recovery device 16, in the second exemplary embodiment, water 20 may be collected for example from the environment of the motor vehicle, e.g. from a rain-water capture system, and/or from the exhaust gas stream of the motor vehicle and/or from the air-conditioning system of the motor vehicle, and supplied to the water tank 10 via the second supply line 17. In the second exemplary embodiment, the metering device 32 may for example also be arranged in the second supply line 17 and/or in the water recovery device 16, and may there emit biocide 30 into the water 20. Furthermore, for example, the second supply line 17 may also comprise inner walls 13 and/or a tank surface 14 of the water injection device 1 on which e.g. one or more coatings 31 may be arranged, which for example may be formed at least partially from biocide 30. For example, a filter 23 may also be arranged in the second supply line 17.

In the first exemplary embodiment of the water injection device according to the invention shown in FIG. 1, and in the second exemplary embodiment of the water injection device according to the invention shown in FIG. 2, several possibilities are depicted for providing biocide in the water injection device. Evidently, water injection devices with some of the possibilities or with arbitrary combinations of some of the possibilities are also conceivable.

Evidently, further exemplary embodiments and mixed forms of the exemplary embodiments shown are also possible.

1. A water injection device for an internal combustion engine of a motor vehicle, comprising:
at least one water injector configured to inject water into an internal combustion engine;
a water tank; and
a first supply line configured to connect the water tank to the at least one water injector, wherein
at least one biocide for combatting harmful organisms in the water injection device is provided in the water injection device.

2. The water injection device according to claim 1, wherein the at least one biocide is provided in the water tank.

3. The water injection device according to claim 1, wherein the at least one biocide is configured as a coating on at least one inner wall of the water injection device.

4. The water injection device according to claim 3, wherein:
the coating is arranged on a tank surface, and
the tank surface is arranged in an interior of the water tank.

5. The water injection device according to claim 1, further comprising:
at least one metering device is configured to release the at least one biocide in the water injection device.

6. The water injection device according to claim 5, wherein the at least one metering device is arranged on or in the water tank.

7. The water injection device according to claim 5, further comprising:
a water recovery device; and
a second supply line, the second supply line configured to connect the water recovery device to the water tank,
wherein the at least one metering device is arranged in at least one of the water recovery device and the second supply line.

8. The water injection device according to claim 5, wherein:
the water tank comprises a filling line for filling water into the water tank, and
the at least one metering device is arranged in the filling line.

9. The water injection device according to claim 5, wherein:
a return line is provided from the first supply line to the water tank, and
the at least one metering device is arranged in the return line.

10. Water injection device according to claim 1, wherein the at least one biocide is at least partially dissolved in water arranged in the water injection device.
